(19) United States
(12) Patent Application Publication
(10) Pub. No.: US 2011/0083493 A1
(43) Pub. Date: Apr. 14, 2011

(54) Liquid Chromatography Detector and Flow Controller Therefor

(75) Inventor: Zhi Xu, St. Louis, MO (US)

(73) Assignee: THE CURATORS OF THE UNIVERSITY OF MISSOURI, Columbia, MO (US)

(21) Appl. No.: 12/997,182

(22) PCT Filed: Jun. 11, 2009
(86) PCT No.: PCT/US09/47029

§ 371 Date: Dec. 9, 2010

Related U.S. Application Data
(60) Provisional application No. 61/060,804, filed on Jun. 11, 2008.

(51) Int. Cl. G01N 30/28

(52) U.S. Cl. 73/61.56

(57) ABSTRACT

A flow controller for use with a liquid chromatography detector. The flow controller includes a flow channel comprising an inlet portion, a control channel portion in communication with the inlet portion, and an outlet portion in communication with said control channel portion. The control channel portion has a cross-sectional area smaller than a cross-sectional area of a drift tube of the liquid chromatography detector for channeling the flow of droplets through the smaller cross-sectional area. The flow controller is shaped and sized to reduce pressure fluctuations and turbulence in the droplet stream of the liquid chromatography detector.

### BACKGROUND

Evaporative light scattering detectors (ELSDs), mass spectrometers, and charged aerosol detectors are used routinely for Liquid Chromatography (LC) analysis. In such a device, a liquid sample is converted to droplets by a nebulizer. A carrier gas carries the droplets through a nebulizing cartridge, an impactor, and a drift tube. Conventional devices place the impactor in the path of the droplets to intercept large droplets, which are collected and exit the drift tube through an outlet drain. The remaining appropriately-sized sample droplets pass through the drift tube, which may be heated to aid in evaporation of a solvent portion of the droplets. As the solvent portion of the droplets evaporates, the remaining less volatile analyte passes to a detection cell, or detector, for detection according to the type of device utilized. In the detection cell of an ELSD, for example, light scattering of the sample is measured. In this manner, ELSDs, mass spectrometers, and charged aerosol detectors can be used for analyzing a wide variety of samples.

Conventional detection devices suffer from various drawbacks, including relatively high levels of jagged peak noise detected by the detection cell. Such excessive jagged peak noise can hamper the ability of the detection device to accurately measure the properties of the sample droplets and can decrease sensitivity overall. One conventional strategy for addressing the baseline noise issue of conventional detection devices is to include a diffuser trapping device for preventing large particles, which can increase background noise, from traveling through the drift tube to the detector. Such diffusers, however, are not capable of eliminating all noise. In addition, such diffusers may cause condensation in the drift tube and peak broadening under operating conditions of the detection device. Peak broadening is particularly troublesome for sharp peaks generated from Ultra Performance Liquid Chromatography (UPLC) where the width of a typical peak is between about 0.8 second and about 1.0 second. Therefore, such conventional detection devices with diffusers are unable to adequately reduce noise and increase sensitivity.

### SUMMARY

The following simplified summary provides a basic overview of some aspects of the present technology. This summary is not an extensive overview. It is not intended to identify key or critical elements or to delineate the scope of this technology. This Summary is not intended to be used as an aid in determining the scope of the claimed subject matter. Its purpose is to present some simplified concepts related to the technology before the more detailed description presented below.

Aspects of the invention relate to new flow controller and impactor technology for liquid chromatography detectors. The flow controller and impactor technology described herein substantially eliminates the jagged peak noise of conventional detection methodologies and significantly reduces the baseline noise for all three detectors mentioned above. Accordingly, aspects of the invention provide a flow controller for a detection device that reduces pressure fluctuations in the droplet flow for decreasing noise and increasing sensitivity. The flow controller includes a flow channel having a cross-sectional area smaller than a cross-sectional area of the drift tube to decrease noise and increase sensitivity, while maintaining adequate signal strength. By reducing such noise, the detection device is capable of achieving a higher level of sensitivity.

### BRIEF DESCRIPTION OF THE DRAWINGS

FIG. 1 is a schematic of an ELSD with a flow controller of one embodiment of the invention with portions partially broken away to reveal internal construction;

FIGS. 2A-2C are exemplary preamplifier chromatograms of 20 ppm Hydrocortisone without the flow controller of the present invention;

FIGS. 3A-3C are exemplary preamplifier chromatograms of 20 ppm Hydrocortisone with a flow controller according to an embodiment of the invention adjacent the impactor;

FIGS. 4A-4C are exemplary preamplifier chromatograms of 20 ppm Hydrocortisone with a flow controller according to an embodiment of the invention arranged about 5 millimeters (0.2 inch) from the impactor;

FIGS. 5A-5C are exemplary preamplifier and backpanel chromatograms of 0.18 mg/mL Ginkoglide B without the flow controller of the present invention;

FIGS. 6A-6C are exemplary preamplifier and backpanel chromatograms of 0.18 mg/mL Ginkoglide B with a flow controller according to an embodiment of the invention.

FIG. 7 is a schematic of an ELSD with a flow controller with portions partially broken away to reveal internal construction according to an alternative embodiment of the invention;

FIG. 8 is a schematic of an ELSD with two flow controllers with portions partially broken away to reveal internal construction according to another alternative embodiment of the invention;

FIG. 9 is a schematic of a flow controller according to an embodiment of the invention;

FIG. 10 is a schematic of a flow controller according to another alternative embodiment of the invention;

FIG. 11 is a schematic of an ELSD with two flow controllers according to an embodiment of the invention;

FIG. 12 is a schematic of an ELSD with three flow controllers according to an embodiment of the invention;

FIG. 13 is an exemplary preamplifier and backpanel chromatograms of 0.18 mg/mL Ginkoglide B without the flow controller of the present invention; and

FIGS. 14A-14B are exemplary preamplifier and backpanel chromatograms of 0.21 mg/mL Ginkoglide B with a first flow controller and a second flow controller according to an embodiment of the invention.

Corresponding reference characters indicate corresponding parts throughout the drawings.

### DETAILED DESCRIPTION

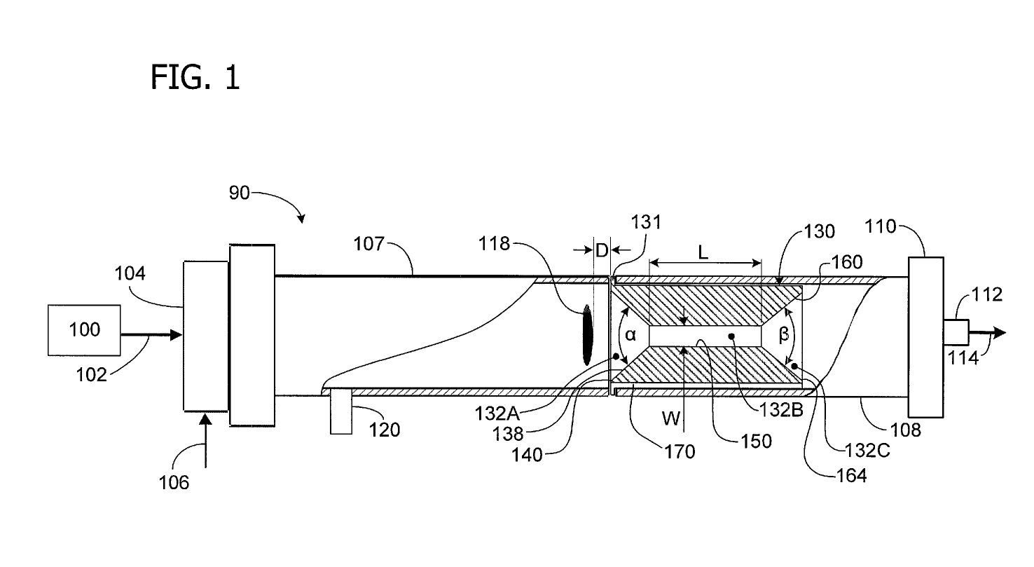

FIG. 1 illustrates an ELSD, generally indicated 90, according to one embodiment of the present invention. As would be understood by one skilled in the art, reference herein to exemplary embodiments of the invention applied to an ELSD are readily applicable to other detection devices, such as mass spectrometers and charged aerosol detectors, for example. A liquid chromatography (LC) column 100 provides effluent 102 (i.e., the mobile phase) to a nebulizer 104. The nebulizer also is provided with carrier gas 106, such as an inert gas (e.g., Nitrogen). As would be understood by one skilled in the art, the nebulizer 104 produces droplets, or a droplet stream, for analysis, which are carried through a nebulizing cartridge 107 and a drift tube 108 of the ELSD 90 by the carrier gas 106. Other mechanisms for moving the droplet stream through the apparatus, such as by an electric field or with a vacuum, may be utilized without departing from the scope of the exemplary embodiments of the invention. The droplets are generally within a size range of between about 10 micrometers (400 microinches) and about 100 micrometers (4 mils). For example, nebulized water droplets range from about 40 micrometers (1.6 mils) to about 60 micrometers (2.4 mils) as the droplets exit the nebulizer 104. In contrast, nebulized acetonitril droplets range from about 15 micrometers (590 microinches) to about 20 micrometers (790 microinches) as the droplets exit the nebulizer 104. Other compounds will form droplets of various size ranges, as would be readily understood by one skilled in the art.

As the carrier gas 106 and droplets flow through the nebulizing cartridge 107 and the drift tube 108, which can be heated, evaporation of the mobile phase 102 (solvent) occurs and the size of the droplets decreases. The gas stream continues by entering a detection cell 110 (e.g., an optical cell), which is the detection module of the unit. The stream passes through the detection cell 110 and out an exit port 112 as a waste gas steam 114. The detection cell 110 is adapted for receiving the droplets for analysis, as would be readily understood by one skilled in the art.

Referring now to FIG. 1, the ELSD 90 additionally comprises an impactor 118 received within the nebulizing cartridge 107 adapted to intercept droplets larger than a particular size carried from the nebulizer 104 through the nebulizing cartridge 107 by the carrier gas 106. The droplets not intercepted are allowed to pass by the impactor 118 through open areas formed between the impactor 118 and the nebulizing cartridge 107.

As would be readily understood by one skilled in the art, the specific shape, position, size, and configuration of the impactor 118 can be altered to control what size droplets are intercepted by the impactor and what portion of the droplet flow is allowed to pass through the open areas. Once intercepted, the collected droplets exit the nebulizing cartridge 107 through an outlet drain 120, which can be positioned either upstream or downstream from the impactor 118. As would be understood by one skilled in the art, any material may be used for the impactor.

Referring again to FIG. 1, an exemplary embodiment of a flow controller of the present invention is generally indicated at 130. The flow controller includes a circumferential flange 131 for mounting the flow controller between the nebulizing cartridge 107 and the drift tube 108. The flow controller includes a flow channel 132 extending from one end of the flow controller to the other. For the flow controller 130 depicted in FIG. 1, the flow channel 132 includes an inlet portion 132A, a control channel portion 132B, and an outlet portion 132C. As would be readily understood by one skilled in the art, the flow controller 130 may be formed from many types of materials, including metals, such as aluminum and stainless steel. Generally speaking, the flow channel 132 has a cross-sectional area smaller than the drift tube 108 for channeling the flow of carrier gas 106 and droplets through the smaller cross-sectional area. As will be explained in greater detail below, the flow controller 130 is shaped and sized to reduce pressure fluctuations and turbulence in the droplet stream.

The inlet portion 132A includes a tapered inlet sidewall 138 extending from an open mouth 140 of the flow controller 130 and narrowing to the size and shape of the cross-section of the control channel portion 132B. In the embodiment shown, the tapered inlet sidewall 138 is substantially conical in shape and extends at an angle α measured between opposite sides of the tapered inlet sidewall. In one exemplary embodiment, angle α is between about 30 degrees and about 120 degrees. In other exemplary embodiments, the angle α is one of about 30 degrees, about 60 degrees, about 82 degrees, about 90 degrees, about 100 degrees, about 110 degrees, and about 120 degrees. Other α angles between about 30 degrees and about 120 degrees not specifically mentioned here may also be utilized without departing from the scope of the present invention. As would be readily understood by one skilled in the art, different α angles may provide different levels of noise reduction, depending upon other parameters of the ELSD 90. As such, modeling and/or experimentation may be required to optimize noise reduction for a particular ELSD apparatus 90.

The control channel portion 132B of the flow controller 130 comprises a generally cylindrical passage 150. In the embodiment shown, the cylindrical passage 150 is substantially circular. Other cross sectional shapes for the cylindrical passage 150 (e.g., elliptical) are also contemplated as within the scope of the present invention. The length L and width W, or diameter, of the control channel portion 132B may be selected to change the flow dynamics of the droplets as they pass through the flow controller 130. In one exemplary embodiment, the length L of the control channel portion 132B is sized between about 13 millimeters (0.5 inch) and about 25 millimeters (1 inch). In another exemplary embodiment, the width W, or diameter, of the control channel portion 132B is sized between about 3 millimeters (0.1 inch) and about 10 millimeters (0.4 inch). Other lengths L and widths W not specifically mentioned here may also be utilized without departing from the scope of the present invention. As would be readily understood by one skilled in the art, different combinations of lengths L and widths W may provide different amounts of noise reduction, depending upon the other parameters of the ELSD 90. As such, some modeling and/or experimentation may be required to optimize noise reduction for a particular ELSD apparatus 90.

The control channel portion 132B can also be defined according to the ratio of the length L to the width W. In one exemplary embodiment, the L/W ratio of the control channel portion 132B is between about 1.5 and about 20. In another exemplary embodiment, the L/W ratio of the control channel portion 132B is between about 2 and about 5. The control channel portion 132B of the flow controller 130 can also be defined according to the ratio of the cross-sectional area of the control channel portion 132B to the cross sectional area of the drift tube 108. When expressed as a percentage, this ratio indicates the flow area of the flow controller 130 as a percentage of the flow area of the drift tube 108. In one exemplary embodiment, this ratio is between about 2 percent and about 20 percent. In other words, the cross-sectional area of flow of the flow controller 130 is between about 2 percent and about 20 percent the size of the flow area of the drift tube 108. In another exemplary embodiment, the cross-sectional area of flow of the flow controller 130 is between about 3 percent and about 10 percent the size of the flow area of the drift tube 108. In still another exemplary embodiment, where the drift tube 108 has an inside diameter of about 22 millimeters (0.9 inch) and the control channel portion 132B of the flow controller 130 has an inside diameter of about 5 millimeters (0.2 inch), the cross-sectional area of flow of the flow controller is about 5 percent the size of the flow area of the drift tube.

The outlet portion 132C of the flow controller 130 also includes a tapered outlet sidewall 160 extending from the cross-section of the control channel portion 132B to an open exit 164 of the flow controller. In the embodiment shown, the tapered outlet sidewall 160 is substantially conical in shape and extends at an angle β measured between opposite sides of the tapered outlet sidewall. In one exemplary embodiment, angle β is between about 30 degrees and about 120 degrees. In other exemplary embodiments, the angle β is one of about 30 degrees, about 60 degrees, about 82 degrees, about 90 degrees, about 100 degrees, about 110 degrees, and about 120 degrees. Other β angles between about 30 degrees and about 120 degrees not specifically mentioned here may also be utilized without departing from the scope of the present invention. As would be readily understood by one skilled in the art, different β angles may provide different levels of noise reduction, depending upon the other parameters of the ELSD 90. As such, some modeling and/or experimentation may be required to optimize noise reduction for a particular ELSD apparatus 90. It should also be noted that the angle α and the angle β of the flow controller 130 may be different from one another without departing from the scope of the embodiments of the present invention.

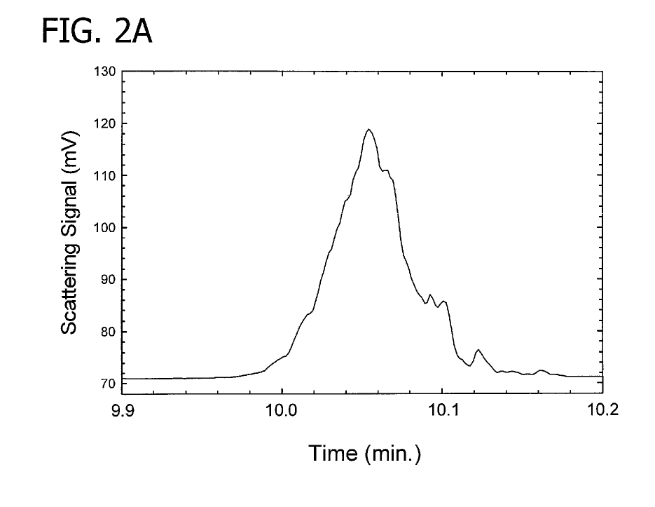

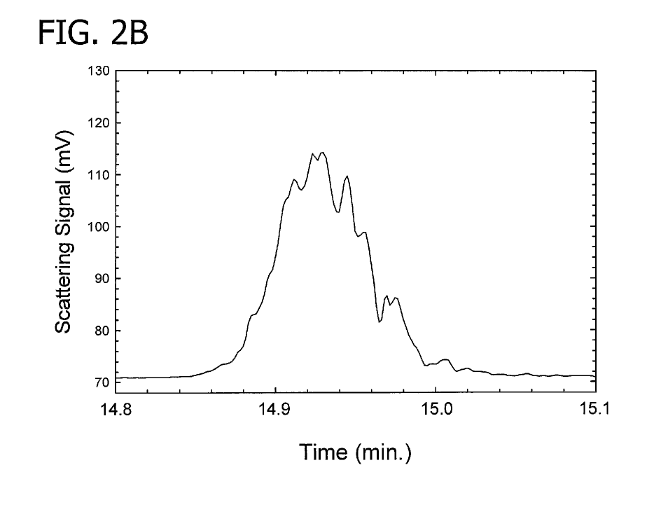

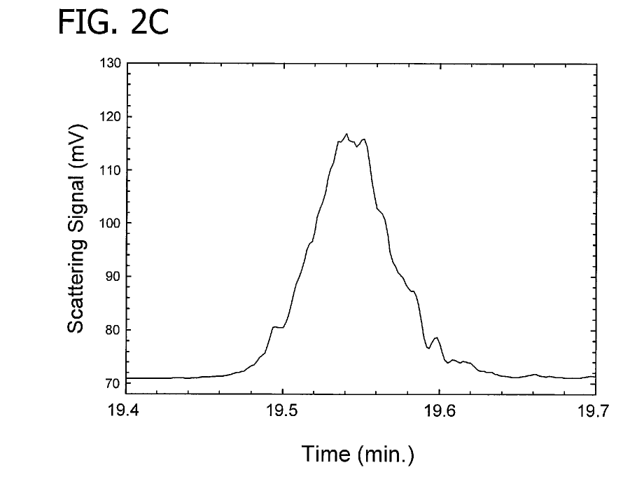

The flow controller 130 is adapted to reduce pressure fluctuations and turbulence in the droplet flow, which is believed to be a substantial cause of noise observed by the detection cell 110. Such noise is exhibited as jagged Gaussian peak shape in chromatographs, as will be explained in detail below with respect to FIGS. 2-6. Without the flow controller 130 described herein, the detection cell 110 detects this pressure fluctuation and turbulence in the droplet flow as increased signal noise.

Without being bound to a particular theory, it is believed that a low pressure region forms adjacent (e.g., above) the nebulizer 104 when a significant liquid flow is introduced into the nebulizer 104. It is believed that this low pressure region adjacent the nebulizer 104 causes an oscillation, or fluctuation, or turbulence, in the droplet flow. The pressure oscillation, or fluctuation, or turbulence, disturbs the laminar flow of the droplet flow. This disturbance can be reduced by changing the boundary condition of the droplet stream. In particular, it is believed that the flow controller 130 changes the boundary condition of the droplet stream, thereby reducing the signal noise detected by the detection cell 110. It is also believed that the flow controller 130 focuses the droplets of the droplet stream into the center of the control channel portion 132B of the flow controller, as at least a portion of the droplet flow fluctuation is believed to be spatial in nature. By focusing the droplets toward the center of the control channel portion 132B, this spatial component of fluctuation can be reduced. Moreover, it is also believed that increasing the length L of the control channel portion 132B will further focus the droplets toward the center of the flow channel 132, thereby further reducing the pressure fluctuation.

In addition to reducing turbulence and peak jaggedness, the flow controller 130 also acts as a secondary impactor and further splits a higher percentage of the mobile phase 102. Both the impactor 118 and the flow controller 130 cause the splitting. Thus, a significant amount of the sample with the mobile phase 102 can drain out of the ELSD apparatus 90. To minimize this loss of mobile phase 102, the size of the impactor 118 may be reduced (e.g., FIG. 1B). By reducing the size of the impactor 118, the loss in the amount of sample from having the flow controller 130 acting as a secondary impactor is reduced. This can help compensate for the sample loss from using the flow controller 130 with the impactor 118.

Over time, liquid can accumulate in the drift tube 108 between the flow controller 130 and the detection cell 110. To address this liquid accumulation, a drain channel 170 formed along the underside of the flow controller 130 extends the length of the flow controller and through the flange 131. This allows the accumulated liquid to flow past the flow controller 130 and flange to the drain 120 located between the nebulizer 104 and the flow controller. As will be explained in greater detail below with respect to the examples of FIGS. 2-6, there is some signal loss associated with reducing the pressure fluctuation with the flow controller 130. In one exemplary embodiment, to reduce this signal loss, the distance D between the impactor 118 and the flow controller 130 can be increased. By increasing the distance D to between about 3 millimeters (0.1 inch) and about 5 millimeters (0.2 inch), the noise reduction is slightly reduced, but the signal loss is lessened considerably. In another exemplary embodiment, the size of the impactor 118 as compared with the nebulizing cartridge 107 can be adjusted to maintain a substantial noise reduction without a significant loss of signal level.

In one exemplary embodiment, the flow controller 130 is removable from at least one of the nebulizing cartridge 107, the impactor 118, and the drift tube 108, such as for inspection, cleaning, and/or replacement. In another exemplary embodiment, the flow controller 130 may be integrally formed with at least one of the nebulizing cartridge 107, the impactor 118, and the drift tube 108.

### EXAMPLE 1

Referring now to FIGS. 2A-2C, preamplifier chromatograms of 20 ppm Hydrocortisone without the flow controller 130 of the present invention are depicted. These chromatograms demonstrate the noise associated with conventional ELSDs. Each of these chromatograms depicts the detected signal at a preamplifier of the ELSD, before any signal processing occurs. As would be readily understood by one skilled in the art, these jagged peaks reduce the overall sensitivity of the ELSD, as the peaks must be processed to remove the jagged peaks, thereby losing precision.

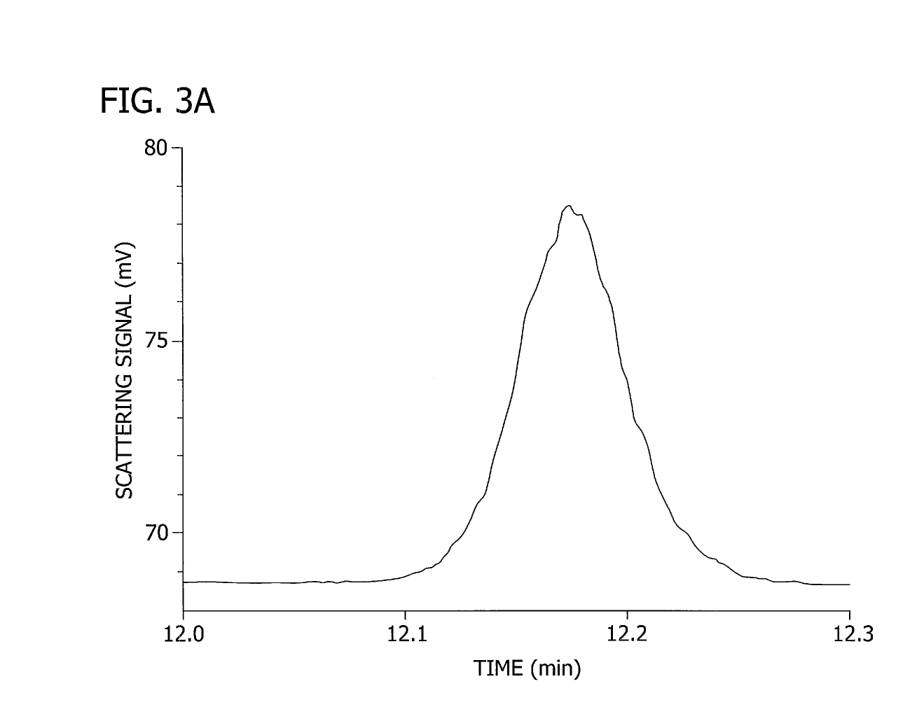

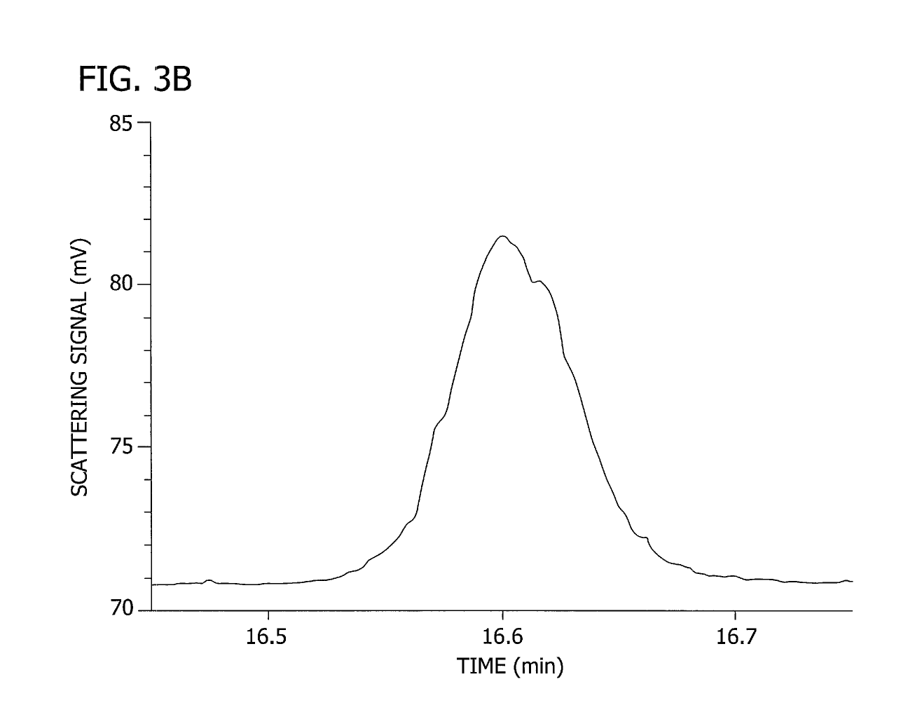

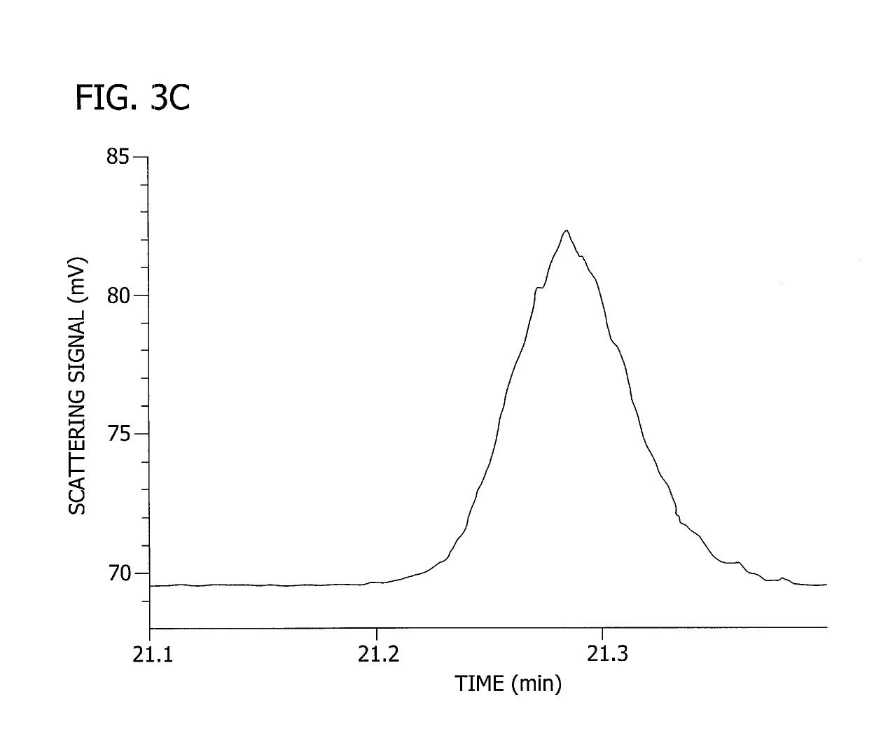

In contrast with the chromatograms of FIGS. 2A-2C, the preamplifier chromatograms of FIGS. 3A-3C for 20 ppm Hydrocortisone depict results with a flow controller 130 of the present invention adjacent the impactor 118. The signals of these chromatograms show a stark improvement over the signals of the chromatograms without the flow controller 130. Comparing FIGS. 2A and 3A, directly, for example, the signal with the flow controller 130 (FIG. 3A) is clearly less jagged than the signal without the flow controller (FIG. 2A). Direct comparisons between FIGS. 2B and 3B and FIGS. 2C and 3C reveal similar results. In each case, the addition of the flow controller 130 reduces noise over the conventional ELSD depicted in FIGS. 2A-2C. It should also be noted here that the signal strength measured by the detection cell 110 is reduced somewhat by the addition of the flow controller 130. Generally, the signal peak without the flow controller 130 is between about 110 millivolts and about 120 millivolts, with the baseline at about 70 millivolts. In contrast, with the flow controller 130, the signal peak is between about 75 millivolts and about 85 millivolts, with the baseline at about 70 millivolts.

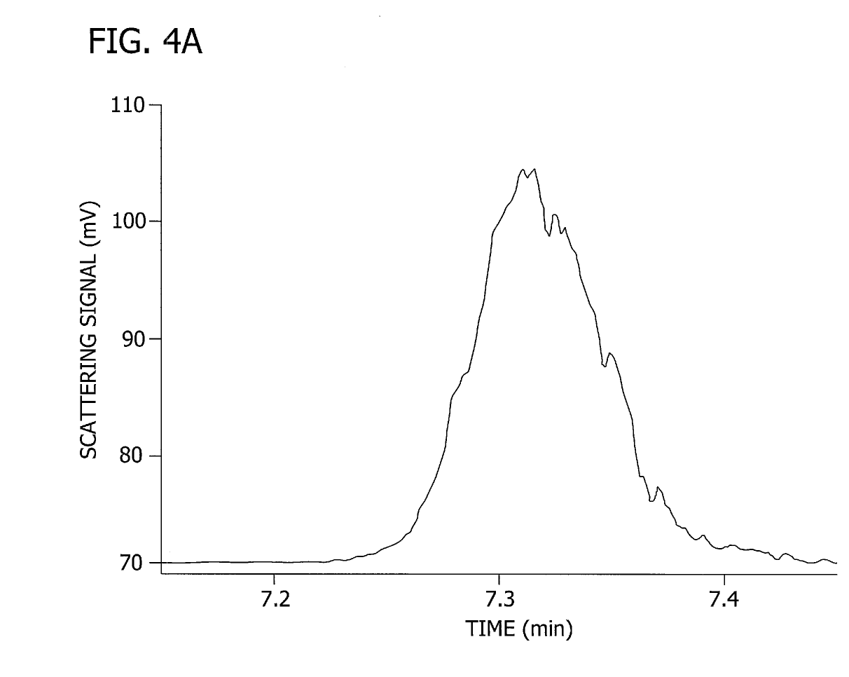

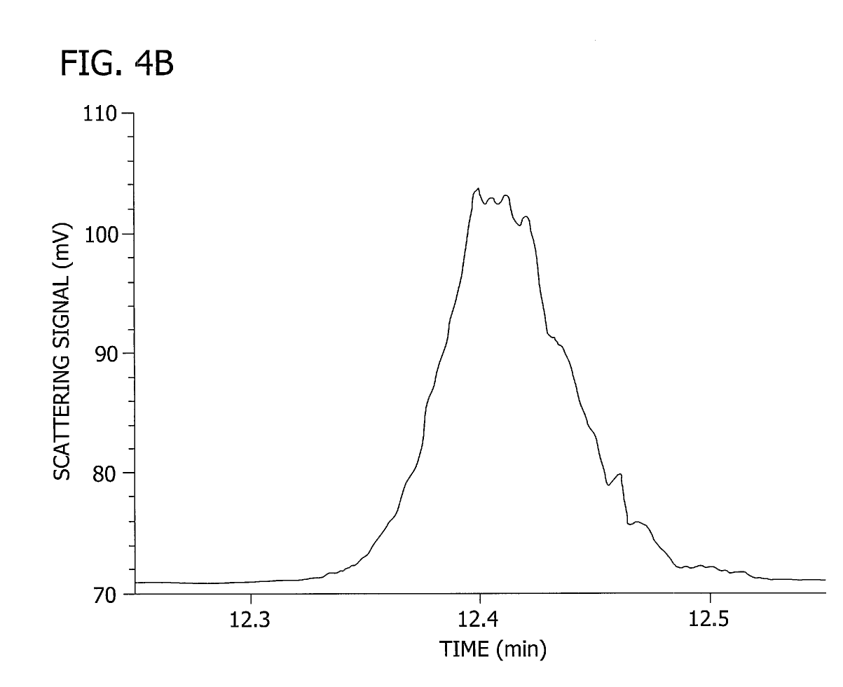

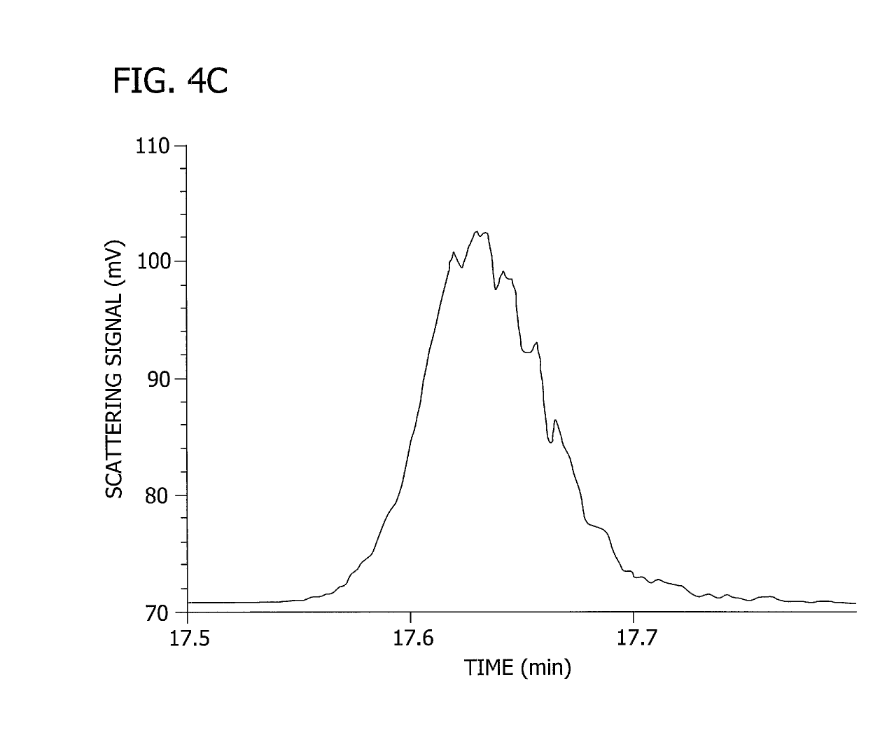

Referring now to FIGS. 4A-4C, chromatograms of 20 ppm Hydrocortisone with a flow controller 130 arranged about 5 millimeters (0.2 inch) from the impactor 118 are depicted. The distance of 5 millimeters (0.2 inch) refers to distance D as defined above and in FIG. 1. Here, the flow controller 130 is spaced from the impactor 118 in an effort to increase signal peak strength, while maintaining reduced noise over convention ELSD chromatographs (e.g., FIGS. 2A-2C). In each case, the addition of the flow controller 130 reduces noise over the conventional ELSD depicted in FIGS. 2A-2C, but increases the signal peak to between about 100 millivolts and about 110 millivolts, with the baseline at about 70 millivolts.

### EXAMPLE 2

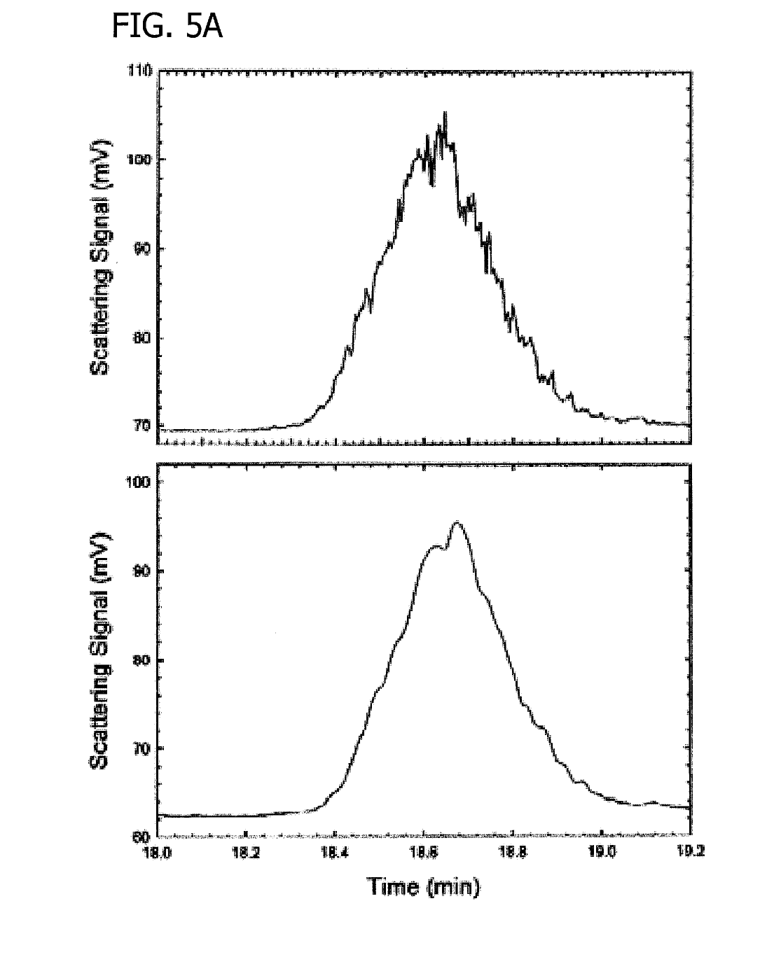

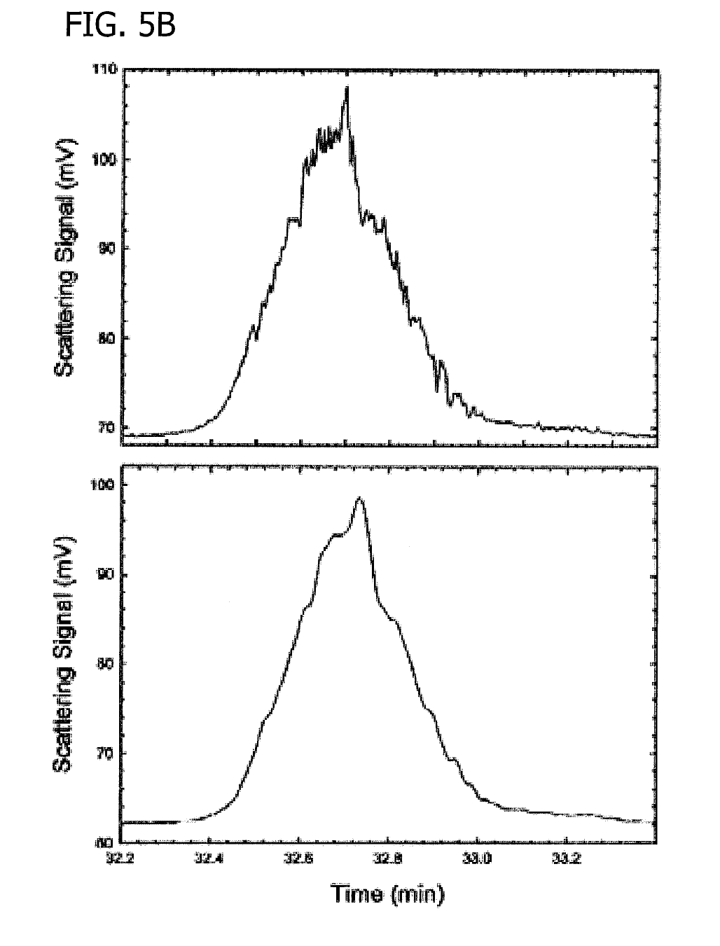

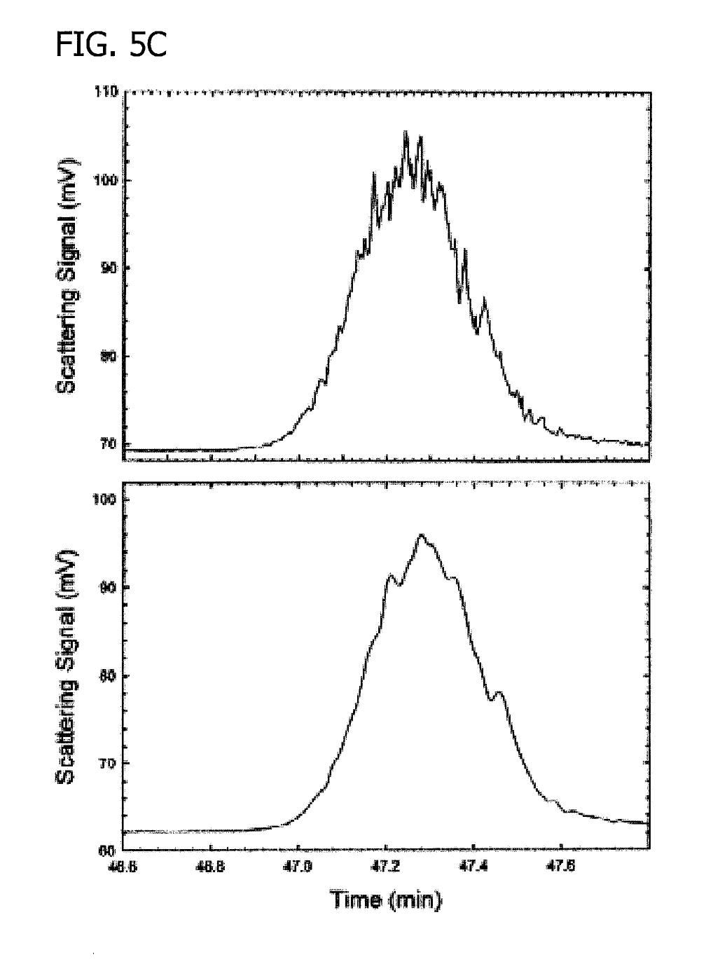

Referring now to FIGS. 5A-5C, exemplary preamplifier and backpanel chromatograms of 0.18 mg/mL Ginkoglide B without the flow controller of the present invention are depicted. The preamplifier chromatographs include substantial noise. Only after the signal is processed is some of the noise removed, as shown in the corresponding backpanel chromatographs. This processing, however, decreases the sensitivity of the ELSD and is not desirable. Moreover, even after the backpanel processing, the chromatographs still include substantial noise in each of FIGS. 5A-5C.

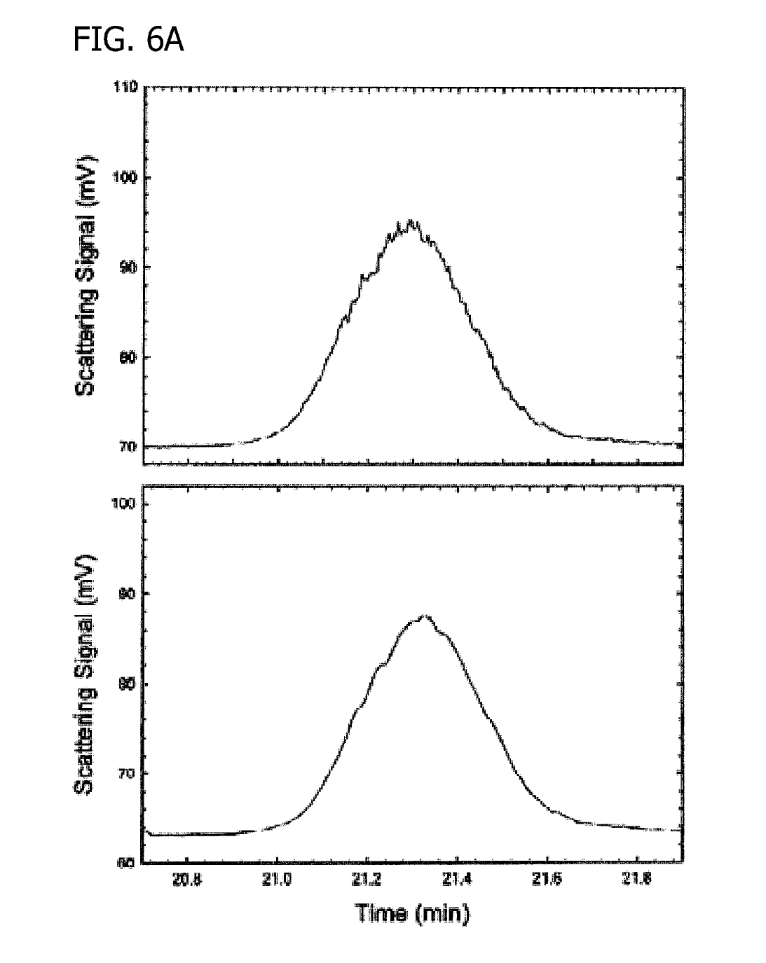

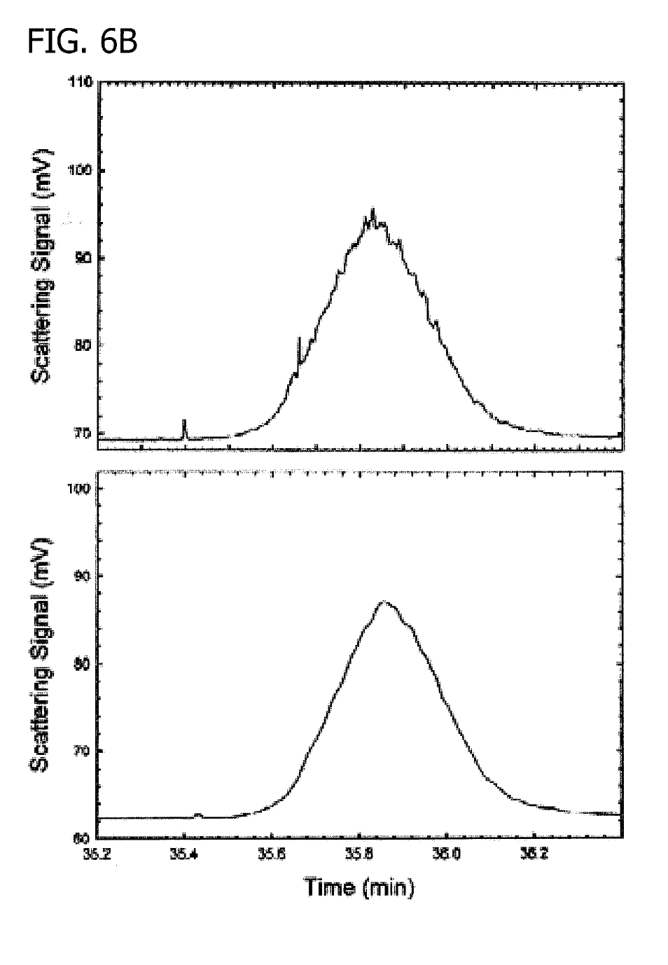

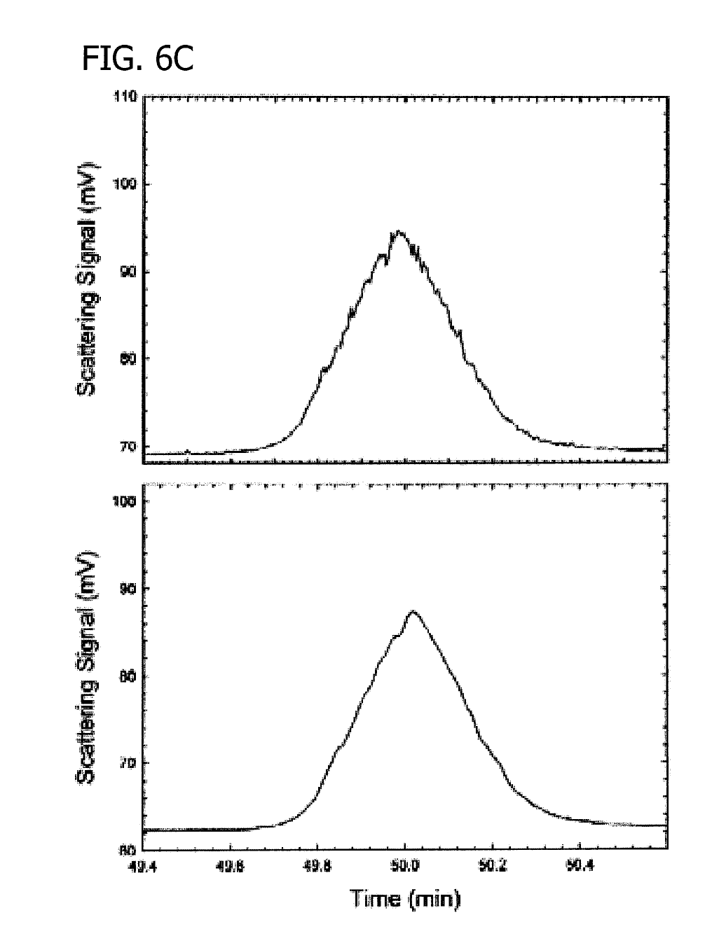

In contrast, FIGS. 6A-6C depict preamplifier and backpanel chromatograms of 0.18 mg/mL Ginkoglide B with a flow controller 130. These preamplifier chromatograms (FIGS. 6A-6C) are created with the flow controller 130 and exhibit significantly less noise than their counterpart chromatograms created without the aid of the flow controller (FIGS. 5A-5C). In particular, comparing FIGS. 5A and 6A, directly, for example, the signal without the flow controller 130 (FIG. 5A) is clearly more jagged and exhibits more noise than the signal with the flow controller (FIG. 6A) for both the preamplifier and backpanel chromatographs. Direct comparisons between FIGS. 5B and 6B and FIGS. 5C and 6C reveal similar results.

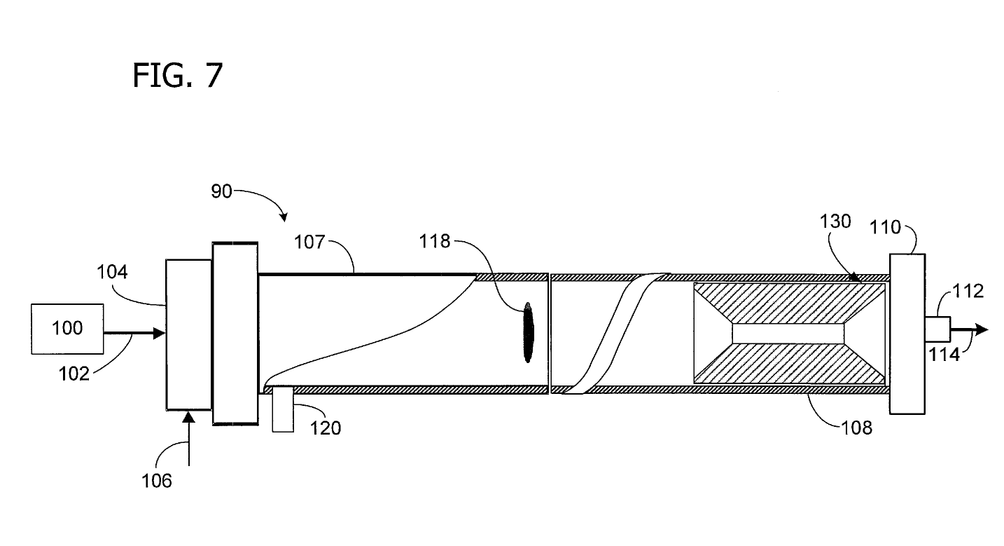

Referring now to FIG. 7, in an alternative embodiment of the invention the flow controller 130 is positioned generally at the exit of drift tube 108 adjacent the detection cell 110 and directly before it in the stream. This embodiment reduces droplet splitting that might be cause by flow controller 130 because of the much smaller droplet size after evaporation in the drift tube 108. Advantageously, reducing droplet splitting consequently eliminates signal reduction. The effectiveness of the configuration is similar to the embodiments described above with respect to the examples.

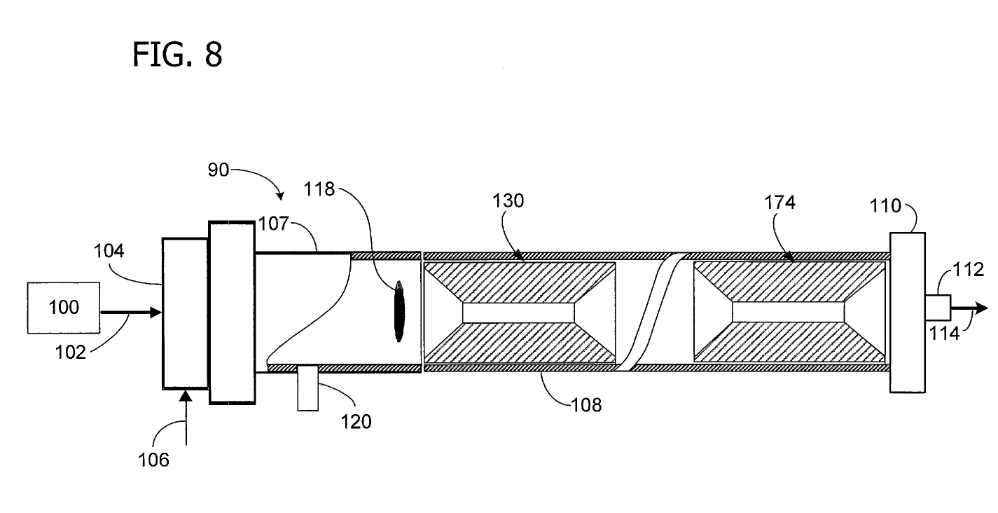

FIG. 8 illustrates another alternative embodiment of the invention in which the flow controller 130 (i.e., a first flow controller) is positioned generally at the entrance of drift tube 108 adjacent the impactor 118 and directly following it in the stream. Another flow controller 174 (i.e., a second flow controller) is positioned generally at the exit of drift tube 108 adjacent the detection cell 110 and directly before it in the stream. This embodiment improves efficiency by removing peak splitting.

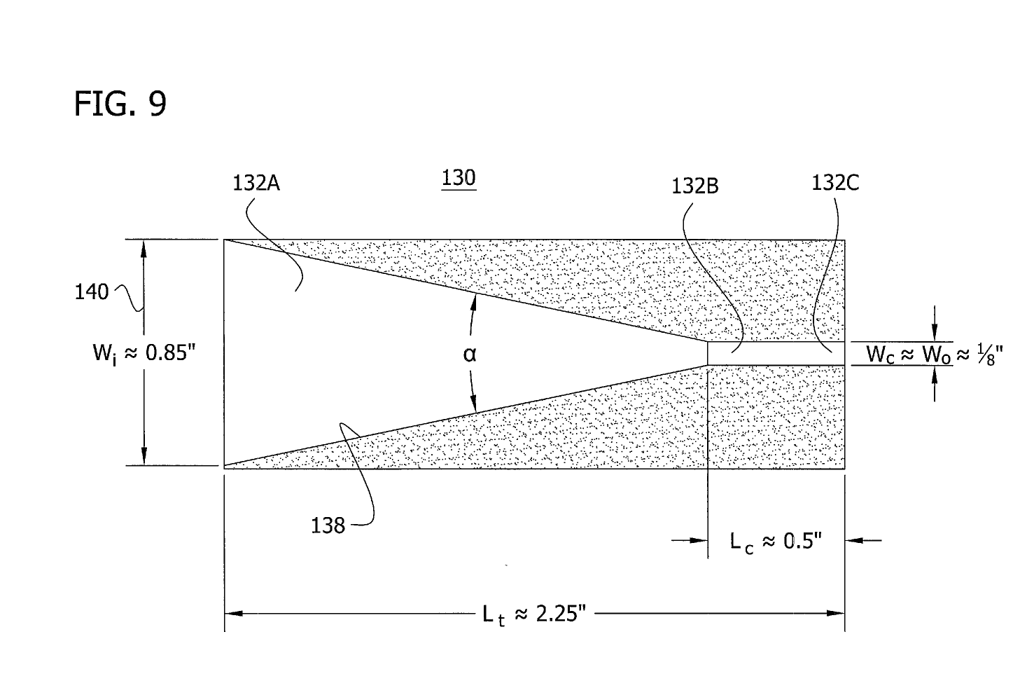

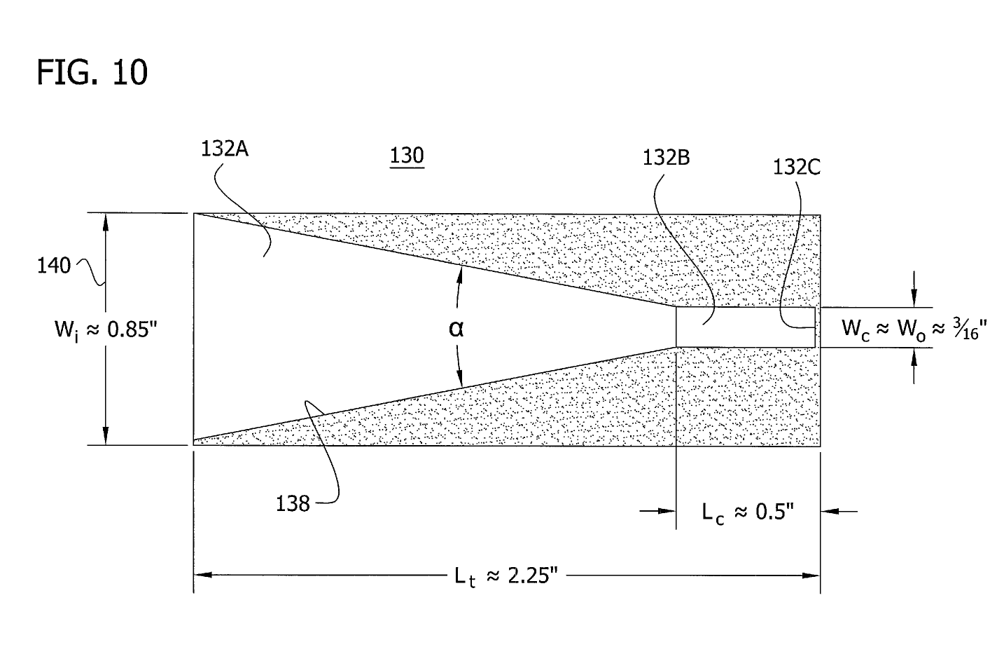

Referring to FIGS. 9 and 10, in yet another alternative embodiment of the invention, the flow controller 130 has an asymmetric shape. The inlet portion 132A includes a tapered inlet sidewall 138 extending from an open mouth 140 of the flow controller 130 and narrowing to the size and shape of the cross-section of the control channel portion 132B. In the embodiments shown in FIGS. 9 and 10, the tapered inlet sidewall 138 is substantially conical in shape and extends at an angle α measured between opposite sides of the tapered inlet sidewall. In one exemplary embodiment, angle α is between about 5 degrees and about 120 degrees. For example, the open mouth 140 has a diameter Wᵢ of about 0.85 inches and the angle α is about 25 degrees. Other open mouth diameters Wᵢ and α angles not specifically mentioned here may also be utilized in order to adjust the level of noise reduction in view of the other parameters of the ELSD. As such, modeling and/or experimentation may be useful to optimize noise reduction for a particular ELSD apparatus.

The control channel portion 132B of the flow controller 130 comprises a generally cylindrical passage 150. In the illustrated embodiments, the cylindrical passage 150 is substantially circular. Other cross sectional shapes for the cylindrical passage 150 (e.g., elliptical) are also contemplated as within the scope of the present invention. The length L_{c} and diameter (e.g., width) W_{c} of the control channel portion 132B may be selected to change the flow dynamics of the droplets as they pass through the flow controller 130. In an exemplary embodiment, the length L_{c} of the control channel portion 132B is about 0.5 inches and the diameter (e.g., width) W_{c} of the control channel portion 132B is between about 0.125 about 0.1875 inches. In the flow controller illustrated in FIG. 9, the length L_{c} of the control channel portion 132B is about 0.5 inches and diameter (e.g., width) W_{c} of the control channel portion 132B is about 0.1875 inches. In the flow controller illustrated in FIG. 10, the length L_{c} of the control channel portion 132B is about 0.5 inches and the diameter (e.g., width) W_{c} of the control channel portion 132B is about 0.125 inches. Other lengths L_{c} and diameters (e.g., widths) W_{c} not specifically mentioned here may also be utilized in order to adjust the level of noise reduction in view of the other parameters of the ELSD. As such, some modeling and/or experimentation may be required to optimize noise reduction for a particular ELSD apparatus.

The outlet portion 132C of the flow controller 130 also connects the control channel portion 132B to an open exit of the flow controller. The outlet portion 132C of the flow controller 130 has a diameter (e.g., width) Wₒ which is smaller than the diameter (e.g., width) Wᵢ of the inlet portion 132A of the flow controller 130. In particular, the diameter (e.g., width) Wₒ of the outlet portion 132C of the flow controller 130 may be substantially equivalent to the diameter (e.g., width) W_{c} of the control channel portion of the flow controller 130. In an exemplary embodiment, the diameter (e.g., width) Wₒ of the outlet portion 132C of the flow controller 130, is between about 0.125 about 0.1875 inches. In the flow controller illustrated in FIG. 9, the diameter (e.g., width) Wₒ of the outlet portion 132C of the flow controller 130, is about 0.125 inches. In the flow controller illustrated in FIG. 10, the diameter (e.g., width) Wₒ of the outlet portion 132C of the flow controller 130, is about 0.1875 inches. Other diameters (e.g., widths) Wₒ of the outlet portion 132C of the flow controller 130 not specifically mentioned here may also be utilized in order to adjust the level of noise reduction in view of the other parameters of the ELSD. As such, some modeling and/or experimentation is contemplated for optimizing noise reduction for a particular ELSD apparatus.

The flow controller 130 has a total length Lₜ which is a function of the selected dimensions (e.g., Wᵢ, α, L_{c}, W_{c}, Wₒ) of the inlet portion 132A, the control channel portion, 132B, and the outlet portion 132C. For example, in the illustrated embodiments, the length Lₜ of the flow controller 130 is about 2.25 inches.

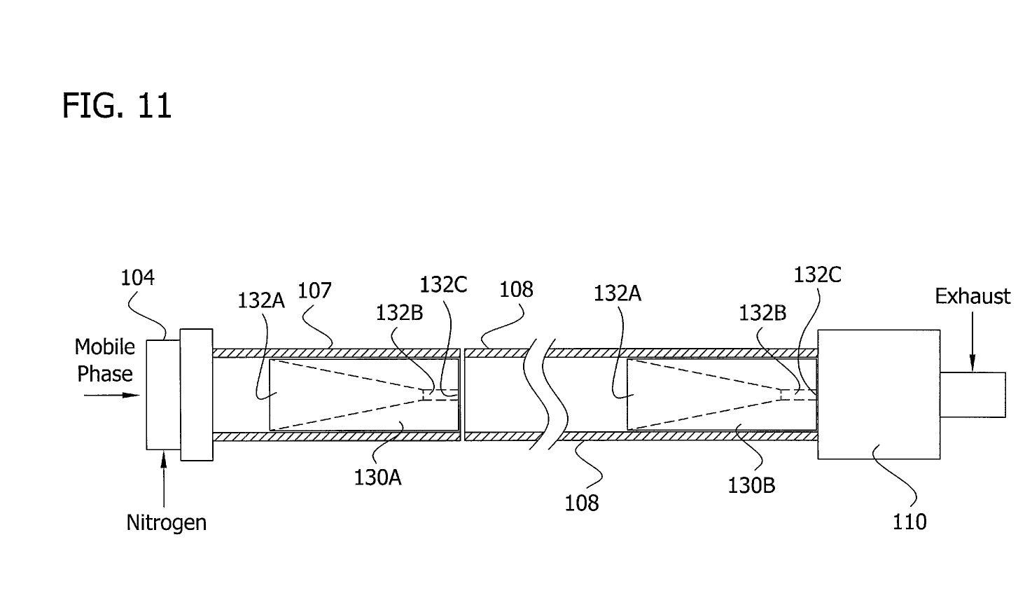

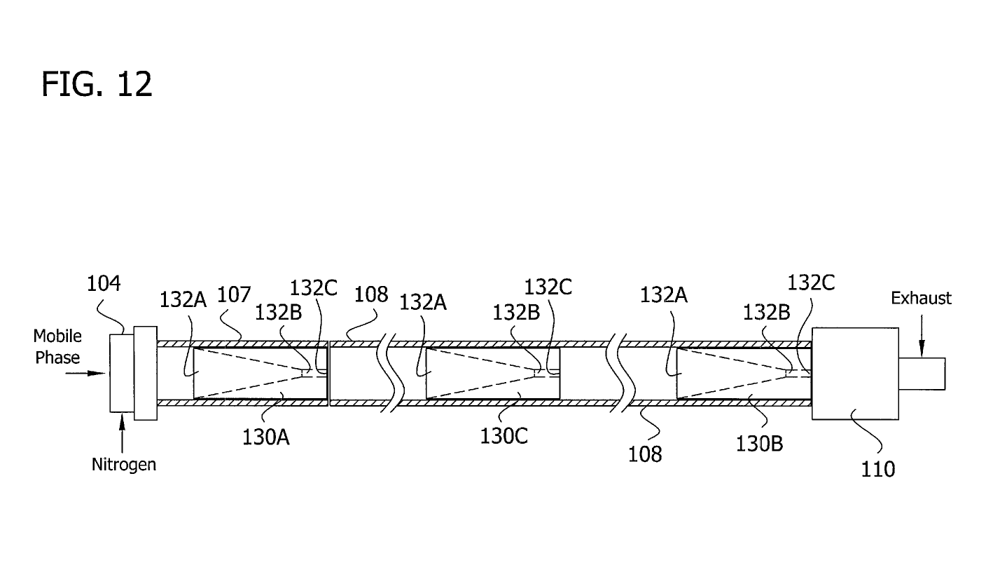

FIG. 11 illustrates an embodiment of the invention in which the flow controller 130A (i.e., a first flow controller) having the asymmetric shape (e.g., flow controller illustrated in FIGS. 9 and 10) is positioned generally in the nebulizer cartridge 107. In particular, the flow controller 130 is positioned in the nebulizer cartridge 107 such that the outlet portion 132C of the flow controller 130A is at the entrance of drift tube 108 and the flow controller 130A is directly before the drift tube 108 in the stream. Another flow controller 130B (i.e., a second flow controller) is positioned generally the drift tube 108 at the exit thereof and adjacent the detection cell 110 (e.g., optical cell) such that the flow controller 130B is directly before the detection cell 110 in the stream. Referring to FIG. 12, in another embodiment a third flow controller 130C is positioned in drift tube 108 such that the third controller 130C is between the first and second flow controllers 130A and 130B in the stream. As discussed below in connection with EXAMPLE 3, aspects of these embodiments increase sensitivity, reduce noise, and produce better peak shape. Additionally, the flow controller 130A that is positioned in the nebulizer cartridge 107 provides a dual function. In addition to controlling the droplet stream, the flow controller 130A provides similar functions as those provided by the impactor 118 (e.g., controlling droplet size), and thus eliminates the need for the impactor 118. As such, the embodiments illustrated in FIGS. 11 and 12 provide a particularly cost effective detection system.

### EXAMPLE 3

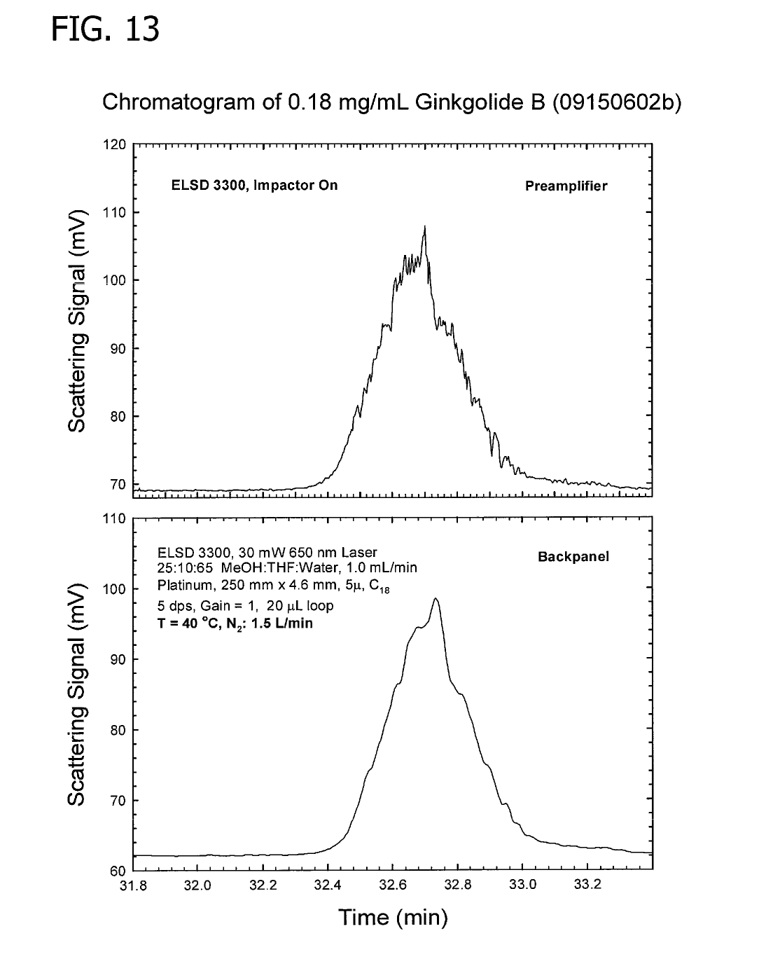

Referring now to FIG. 13, exemplary preamplifier and backpanel chromatograms of 0.18 mg/mL Ginkoglide B without the flow controllers 130A and 130B. The preamplifier chromatograph includes substantial noise. Only after the signal is processed is some of the noise removed, as shown in the corresponding backpanel chromatograph. This processing, however, decreases the sensitivity of the ELSD and is not desirable. Moreover, even after the backpanel processing, the chromatograph still includes substantial noise.

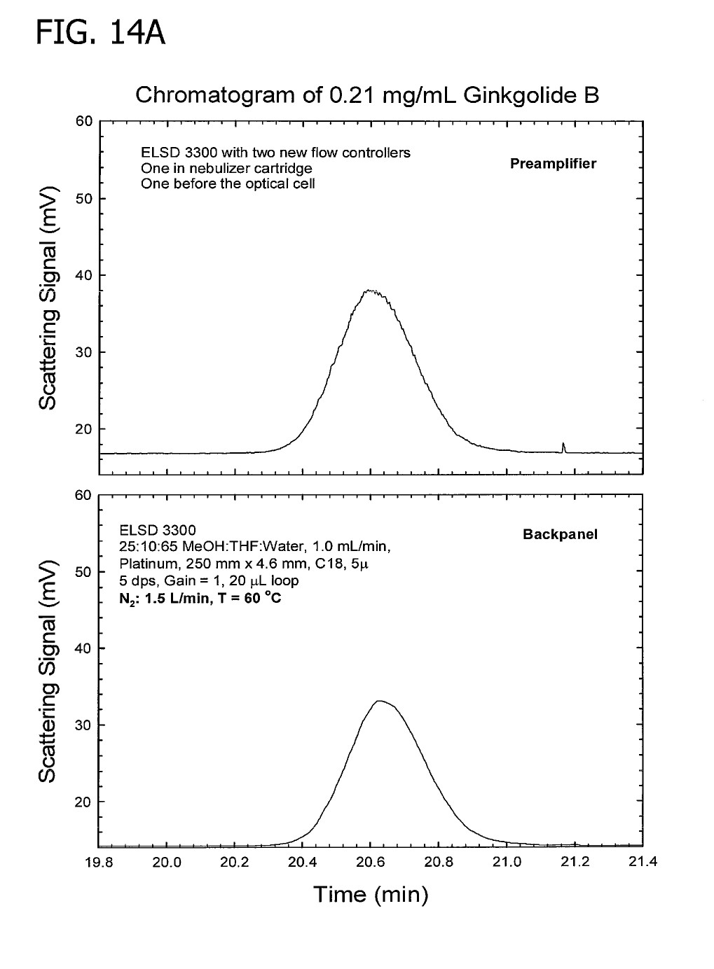

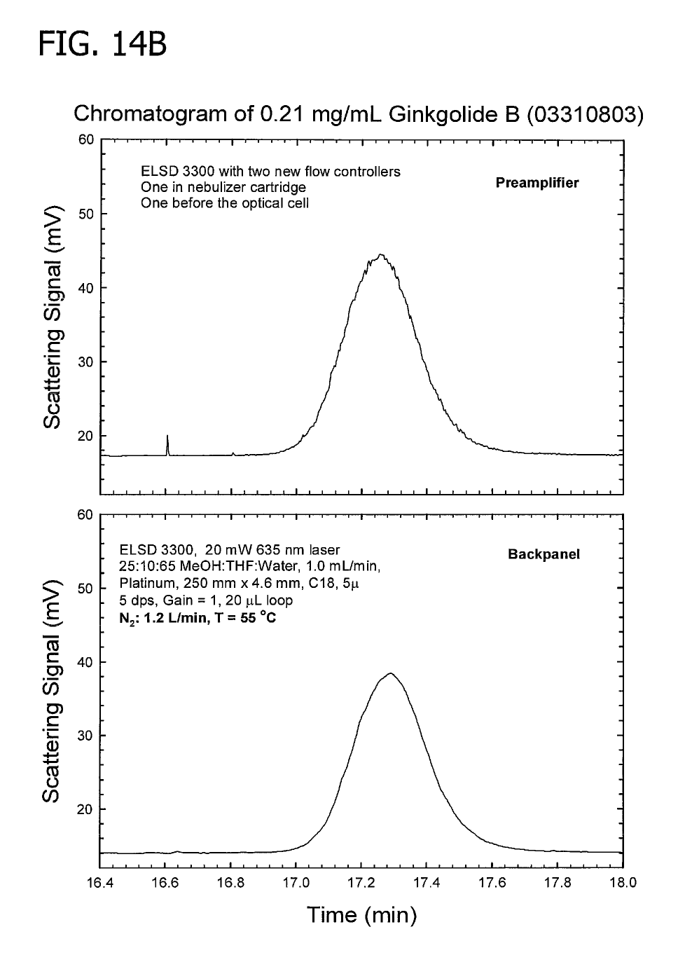

In contrast, FIGS. 14A and 14B depict preamplifier and backpanel chromatograms of 0.21 mg/mL Ginkoglide B created with the flow controller 130A positioned in the nebulizer cartridge 107 and the flow controller 130B positioned in the drift tube 108 so that it is before the detection cell 110 in the stream. These preamplifier chromatograms (FIGS. 14A-14B) exhibit significantly less noise than their counterpart chromatograms created without the aid of the flow controllers (FIG. 13). For example, as apparent from a comparison of FIG. 13 to FIGS. 14A-14B, the signal without the flow controllers 130A and 130B is clearly more jagged and exhibits more noise than the signal with the flow controllers (FIG. 14A-14B) for both the preamplifier and backpanel chromatographs.

Aspects of the present invention are applicable to numerous detection methodologies and systems, including but not limited to Liquid Chromatography Detectors such as ELSDs, Charged Aerosol Detectors, and Mass Spectrometers. The new flow controller technology increases sensitivity, reduces noise, and produces better peak shape for three LS detectors mentioned above. This will translate into higher quality data, better quality control (QC) and higher productivity for customers. This new design also provides reduced manufacturing costs (e.g., reduced by more than $120 per unit compared to a conventional ELSD) by eliminating the need for a impactor. Moreover, implementation of embodiments of the present invention in combination with an improved laser (e.g., a new 20 mW 635 nm laser) provides even greater manufacturing cost reductions (e.g., reduced by more than $200 per unit), and with a much smaller baseline offset, lower baseline noise, better peak shape, and much better reproducibility. As demonstrated herein, the baseline is extremely stable over day to day operation.

Aspects of the improved flow controller are contemplated for implementation into a Flash ELSD system to reduce the effect of drift tube temperature on peak shape.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above products and methods without departing from the scope of the invention, it is intended that all matter contained in the above description and shown in the accompanying drawings shall be interpreted as illustrative and not in a limiting sense.

What is claimed is:

1. A liquid chromatography detector comprising:
a nebulizer producing droplets for analysis;
a detection cell adapted for receiving the droplets produced by the nebulizer for analysis by the detection cell;
a drift tube arranged between the nebulizer and the detection cell adapted for guiding the droplets from the nebulizer to the detection cell as a droplet stream through the drift tube; and
a flow controller arranged in the nebulizer and in communication with the drift tube for transmitting the droplet stream from the nebulizer, said flow controller comprising a flow channel with a flow channel inlet and a flow channel outlet, wherein the diameter of the flow channel inlet is greater than the diameter of the flow channel outlet.

2. A liquid chromatography detector as set forth in claim 1 wherein the flow controller includes a control channel portion between the flow channel inlet and the flow channel outlet, said control channel portion having a cross-sectional area that is smaller than the cross-sectional area of the drift tube.

3. A liquid chromatography detector as set forth in claim 2 wherein the flow channel inlet comprises a tapered inlet sidewall extending from an open mouth of the flow controller and narrowing to the size and shape of the cross-section of the control channel portion.

4. A liquid chromatography detector as set forth in claim 3 wherein said tapered inlet sidewall extends at an angle α measured between opposite sides of the tapered inlet sidewall, said angle α being about 25 degrees.

5. A liquid chromatography detector as set forth in claim 1 wherein the flow controller includes a control channel portion between the flow channel inlet and the flow channel outlet, said flow channel outlet having a diameter that is substantially the same as the diameter control channel portion.

6. A liquid chromatography detector as set forth in claim 1 wherein the flow channel outlet diameter is between about 0.125 inches and 0.1875 inches.

7. A liquid chromatography detector as set forth in claim 6 wherein the flow channel inlet diameter is between about 0.85 inches.

8. A liquid chromatography detector as set forth in claim 1 further comprising another flow controller arranged between the nebulizer and the detection cell and in communication with the drift tube for receiving the droplet stream, said other flow controller comprising a flow channel having a cross-sectional area smaller than a cross-sectional area of the drift tube for channeling the flow of the droplet stream through the smaller cross-sectional area, said flow controllers being shaped and sized to reduce turbulence in the droplet stream received by the detection cell.

9. A liquid chromatography detector as set forth in claim 1 further comprising another flow controller arranged between the nebulizer and the detection cell and in communication with the drift tube for receiving the droplet stream, said other flow controller comprising a flow channel with a flow channel inlet and a flow channel outlet, said flow channel inlet having a diameter greater than that of the flow channel outlet, said flow controllers being shaped and sized to reduce turbulence in the droplet stream received by the detection cell.

10. A liquid chromatography detector as set forth in claim 9 wherein the flow controller comprises a first flow controller and the other flow controller comprises a second flow controller, and further comprising a third flow controller arranged between the first and second flow controllers and in communication with the first and second flow controllers.

11. A flow controller for use with a liquid chromatography detector comprising a nebulizer producing droplets for analysis, a detector adapted for analyzing the droplets, a drift tube shaped and sized for guiding the droplets from the nebulizer to the detector, said drift tube having a cross-sectional area, said flow controller comprising:
a flow channel comprising,
an inlet portion having an inlet diameter;
a control channel portion in communication with said inlet portion; and
an outlet portion in communication with said control channel portion, said outlet portion having diameter that is smaller than the inlet diameter.

12. A liquid chromatography detector as set forth in claim 11 wherein the control channel portion has a diameter, said control channel diameter being substantially the same as the outlet diameter.

13. A liquid chromatography detector as set forth in claim 11 wherein the control channel portion has a diameter, and the control channel diameter and the outlet diameter are each between about 0.125 inches and 0.1875 inches.

14. A liquid chromatography detector as set forth in claim 11 wherein the flow channel has a length of about 2.25 inches.

15. A liquid chromatography detector comprising:
a nebulizer producing droplets for analysis;
a detection cell adapted for receiving the droplets produced by the nebulizer for analysis by the detection cell;
a drift tube arranged between the nebulizer and the detection cell adapted for guiding the droplets from the nebulizer to the detection cell as a droplet stream through the drift tube; and
a flow controller arranged between the nebulizer and the detection cell and in communication with the drift tube for receiving the droplet stream, said flow controller comprising a flow channel with a flow channel inlet and a flow channel outlet, wherein the flow channel outlet has a diameter and the flow channel inlet has a diameter, said flow channel outlet diameter being smaller than said flow channel inlet diameter and being in communication with the detection cell.

16. A liquid chromatography detector as set forth in claim 15 wherein the flow controller includes a control channel portion between the flow channel inlet and the flow channel outlet for channeling the flow of the droplet stream, said control channel portion having a cross-sectional area that is smaller than the cross-sectional area of the drift tube.

17. A liquid chromatography detector as set forth in claim 16 wherein the flow channel inlet comprises a tapered inlet sidewall extending from an open mouth of the flow controller and narrowing to the size and shape of the cross-section of the control channel portion.

18. A liquid chromatography detector as set forth in claim 17 wherein said tapered inlet sidewall extends at an angle α measured between opposite sides of the tapered inlet sidewall, said angle α being about 5 degrees.

19. A liquid chromatography detector as set forth in claim 15 wherein the flow controller includes a control channel portion between the flow channel inlet and the flow channel outlet for channeling the flow of the droplet stream, said control channel portion having a diameter that is substantially the same as the diameter of the flow channel outlet.

20. A liquid chromatography detector as set forth in claim 15 wherein the flow channel outlet diameter is between about 0.125 inches and 0.1875 inches.

21. A liquid chromatography detector as set forth in claim 20 wherein the flow channel inlet diameter is between about 0.85 inches.

22. A liquid chromatography detector as set forth in claim 15 further comprising another flow controller arranged in the nebulizer and in communication with the drift tube for transmitting the droplet stream, said other flow controller comprising a flow channel having a cross-sectional area smaller than a cross-sectional area of the drift tube for channeling the flow of the droplet stream through the smaller cross-sectional area, said flow controllers being shaped and sized to reduce turbulence in the droplet stream received by the detection cell.
